(19) United States
(12) Patent Application Publication
(10) Pub. No.: US 2011/0248057 A1
(43) Pub. Date: Oct. 13, 2011

(54) Tote Tether

(76) Inventor: Patricia Schmitz, Mims, FL (US)

(21) Appl. No.: 13/078,963

(22) Filed: Apr. 2, 2011

Related U.S. Application Data
(60) Provisional application No. 61/322,929, filed on Apr. 12, 2010.

(51) Int. Cl. A45F 5/00; F16M 13/02

(52) U.S. Cl. 224/275; 248/95; 294/142

(57) ABSTRACT

An elongated strap with a first and second connecting snap to support one or a plurality of hanging items. Each end of the strap is folded on itself and snapped in position along the interior of the strap, forming two closed loops. The first loop may be secured by hand or to an external support, such as a vehicle seat headrest, a shopping cart or similar structure. The second loop passes through the handles of reusable grocery bags, hand bags or totes to securely hold and organize the items. The strap itself is a high strength material that can support the load of the suspended items and is adorned with a decorative pattern or color on its outer surface. In use, the device is intended to organize empty grocery totes along the outer rim of a grocery cart while shopping, as well as organize and store empty totes on the backside of a vehicle seat.

### CROSS REFERENCE TO RELATED APPLICATION

This application claims the benefit of U.S. Provisional Application No. 61/322,929 filed on Apr. 12, 2010, entitled “Tote Tether”

### BACKGROUND OF THE INVENTION

1. Field of the Invention

The present invention relates to carrying and support devices for reusable shopping bags, hand bags and other totes. More specifically, the present invention relates to an elongated strap device with connecting snaps that can support articles from an external support structure or be carried by hand.

2. Description of the Prior Art

Organizing empty grocery totes is of particular interest to those that employ environmentally conscious means for storing and transporting groceries. Reusable totes are generally cloth or vinyl bags with elongated handles for carrying groceries from a market to a home. Generally, several of these bags are utilized and placed in a cart while shopping. Groceries are piled on top and around the bags, limiting one's access to the bags once the user is scanning and paying for the items. Groceries are forced out of the way to grasp the bags, in order to utilize them for transporting the items. Alternatively, the bags are placed on the top shelf of a grocery cart. However, this area may be limited if a child is onboard or if delicate items are stored on the upper shelf.

When traveling to the market, it is also common for consumers to forget reusable tote bags. Generally these are stored indoors or spread around a household, increasing the likelihood of forgetting to load the bags in a vehicle prior to traveling to a grocery market.

Carrying and organizing shopping bags and other handled totes can likewise be a difficult and physically intensive task. Grocery shopping can result in several items and associated bags, either plastic grocery bags or reusable tote bags with associated handles. For those that live in a city or those that transport the bags over a long distance, the user must place several straps on each hand or along an arm to move the bags simultaneously. Those users able to drive to a market or store have to concern themselves with shifting contents within the vehicle in response to changes in the momentum during transport.

A device is required that eliminates the known problems associated with organizing, transporting and carrying reusable tote bags, particularly one that improves organization while shopping with a grocery cart and while transporting empty or filled tote bags.

Several devices are known in the art for organizing articles by hand or in a vehicle, including strap devices, handle attachment devices and other securement means to a vehicle seat lap or seat back. These devices can be separated into two categories: those that improve hand-carrying several articles and those that mate to a structure to secure and organize a plurality of items.

Patents that describe hand-carrying means improve the organization and reduce stress associated with simultaneously carrying several bags with handles straps thereon. U.S. Pat. No. 6,901,635 to Scola describes a unitary shopping bag carrier with a handle and locking member for securing the handles of several bags below the handle. The locking member is a surface that loops through the bags and locks into the handle portion to provide a solid support loop for the bag handles. The design of this device is relatively complicated, including a locking means that relies on the vertical weight of the bags for securement.

U.S. Pat. No. 5,695,234 to Coticchio describes a shopping bag carrier device that utilizes two opposed handles joined by a unitary strap. A first handle is looped through the handles of several bags and joined with a second handle to support the handles with a folded section of the strap. The handles are clasped together by the user and carried using one hand. In an alternate embodiment, the second handle is replaced with a closed loop, in which the first handle is looped through the bag handles and then through the attached closed loop to secure the assembly and allow hand carrying with a single hand.

U.S. Pat. No. 6,045,019 to Moses describes a unique sheet of material shaped in such fashion to support both handles of a shopping bag independently, using a pair of lateral hooks. Several hooks line each side of the sheet, with an inner section designed to be held by hand or slung over a user's shoulder for supporting the load of the suspended bags.

U.S. Pat. No. 5,150,938 to Gans describes a grip supplement comprising a bar grip and associated cable for looping through a plurality of bag handles. The cable is fixed to a first end of the bar grip, and slideably detaches from a second end, allowing the cable to be passed through the closed looped handles of grocery and tote bags. The handle provides the user an improved means for carrying several bags, reducing stress on the fingers and hand.

The aforementioned hand carrying devices are all related to single use products that improve a user's ability to carry several handled articles with a strap, handle or associated device. No mention is made to multiple use devices, in which the same device can be utilized for hand carrying and for securing the assembly to a larger structure, such as a seat head rest or grocery shopping cart. Those devices in the art that describe straps for seats are listed below.

U.S. Pat. No. 5,226,576 to Ellsworth describes a vehicle seatback waste receptacle that utilizes a series of straps to support a pleated container. The device attaches around the seat back and to the posts of the seat head rest. U.S. Pat. No. 7,614,689 to Fowler describes another vehicle seat mounted tether, comprising hook and loop fastener attachment to a seat bolster. The strap secures cargo on the lap of the seat, allowing a user the ability to access items from the cargo while driving or while seated next to the tethered assembly. U.S. Published Patent Application No. 2009/0245963 to Schoor describes a final vehicle seat tether in which an elongated strap is utilized to secure cargo to the lap of a vehicle seat.

These prior art devices have a common drawback, most notably that they serve a singular purpose and are designed only for that intent. The disclosed invention differs in structure from the prior art and in intended purpose. The disclosed invention fills the role of two devices, providing both a tote hand carrying device and a device to suspend and organize a plurality of totes from another structure. The device requires only that the support structure have a pole or circumferentially accessible support to wrap its first end around, and space to suspend a series of handled bags or other items. In its intended role, the device provides a means to organize tote bags on the outside of a shopping bag, on the backside of a seat, or to provide a means to carry several bags simultaneously.

### SUMMARY OF THE INVENTION

In view of the foregoing disadvantages inherent in the known types of tote support straps now present in the prior art, the present invention provides a new tote support strap wherein the same can be utilized for providing convenience for the user when hand carrying or otherwise suspending a plurality of totes or handled bags.

It is therefore an object of the present invention to provide an elongated strap with a plurality of attachment snaps in which a first end of the strap may be folded on itself to provide a handle or attachment support loop, and a second end that may be interlooped through a plurality of bag handles and secured with another snap to support the bags with a second closed loop.

Another object of the present invention is to provide a tote strap that is simplistic in its structure, yet applicable and having utility in several common scenarios regarding shopping, transporting or storing totes with handles.

Yet another object of the present invention is to provide a decorative strap and snap device that can be adorned in several styles, one that has sufficient tensile strength and snap closure strength to support load exerted from suspended articles.

Other objects, features and advantages of the present invention will become apparent from the following detailed description taken in conjunction with the accompanying drawings.

### BRIEF DESCRIPTIONS OF THE DRAWINGS

FIG. 1 shows a side view of the disclosed invention.

FIG. 2 shows a view of the disclosed invention in a working position, supporting a plurality of suspended tote bags from the post of a vehicle head rest.

### DETAILED DESCRIPTION OF THE INVENTION

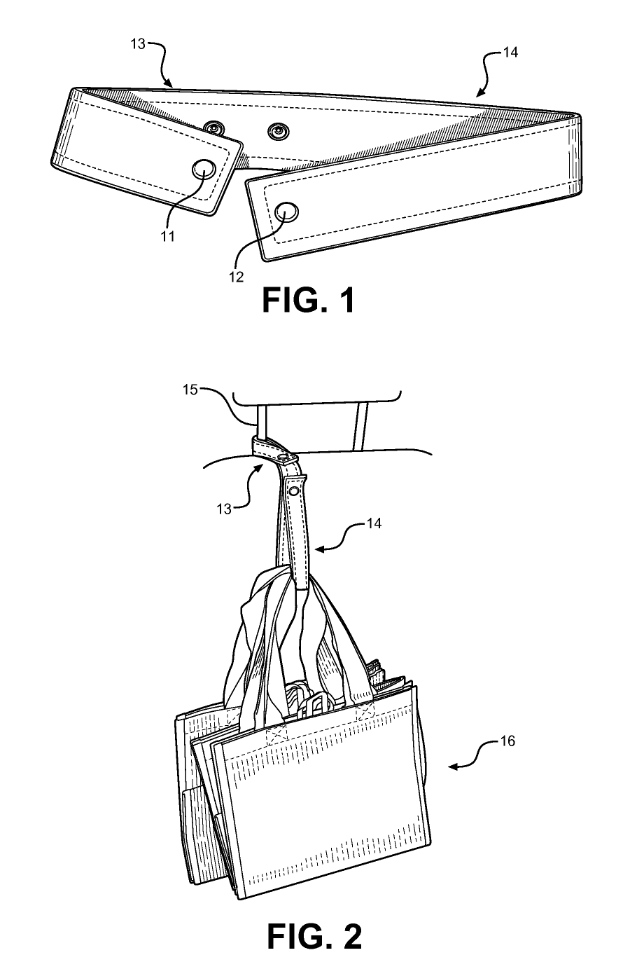

Referring now to FIG. 1, there is shown a side view of the strap device, in which a first and second end are shown with a first 11 and second 12 snap button closure. The first end of the strap is folded over itself to form a first loop 13. The first loop is secured with a first snap button 11 closure, forming a secure loop to hand carry or to secure to a larger structure. When attaching to a larger structure, the first end is wrapped around a pole or other circumferentially accessible member to form a closed loop 13 with the structural member engaged therethrough. The structure is utilized as a support and bears into the first loop 13, supporting load from suspended articles. A second end of the strap is placed through a plurality of handles and folded on itself, forming a second loop 14. The second loop 14 is secured with a second snap button closure 12.

Referring now to FIG. 2, there is shown the strap device in a working position, wherein several totes bags 16 are suspended from the post 15 of a vehicle head rest. The first loop 13 of the strap wraps around the post 15 and snaps together to form a closed loop around the supporting feature. The second loop 14 is placed through the handles of a series of tote bags 16 and is snapped closed. In this form, the bags 16 are organized and supported for travel in a vehicle, responding to changes in momentum by swinging from the post 15 and utilizing the post's structural features for support.

In use an individual may choose to suspend one or more bags or totes using the strap device. The strap can be used as an aid when hand carrying several bags, in which the device reduces strain on the user's hand and organizes the bags in one location. The strap can likewise be utilized to suspend one or more bags from a vehicle head rest, shopping cart or other support structure preferred by the user. The bags may be suspended from a seat head rest post prior to grocery shopping, to ensure the totes are taken from the home and utilized at the market. Once in the grocery market, the strap can be fixed to the upper rim of a shopping cart, dangling the tote bags outside of the cart and away from the groceries loaded therein. This provides easy access to the totes during the check-out process. In this way, the totes are organized and utilized effectively, reducing unnecessary waste associated with using disposable bags when the totes are left at home. When suspending the items from a user, the strap can be held by hand or the user's arm can be sent through the first loop and the loop rested on the user's forearm.

The strap itself is comprised of a high strength material that can be adorned in several different styles, colors or fashions. The material may be chosen from an array of acceptable materials that meets the tensile strength requirements of supporting several tote bags, including the bearing and pull-through strength requirements introduced by the snap closures, and the requirement that the material accept decoration or other pattern. These include fabrics, plastics, leather, or other material that meets the requirements for the disclosed invention.

The snaps themselves must be capable of maintaining engagement while undergoing separation load across the male and female bonds of the snap button. Along with snaps, the loop closure means may utilize hook and loop fastening, button closure or other acceptable means that one skilled in the art would utilize for the given purpose of maintaining tether integrity. Appropriate sizing of the strap depends on user preference, material strength and availability, and intended application. One embodiment of the strap employs a strap width of one inch and eighteen inches in length. Actual dimensions may vary.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A strap device for organizing and supporting one or a plurality of totes bags, comprising:
an elongated strap with a first and second end and a first and second closure means along its length;
said first end is folded on itself to form a first closed loop, said first loop is secured with said first closure means;
said second end is placed through handles of one or a plurality of said totes and folded on itself to form a second closed loop, said second loop is secured with said second closure means.

2) A strap device according to claim 1, wherein said first loop is supported by a grocery cart, said totes engaged and suspended from said second loop.

3) A strap device according to claim 1, wherein said first loop is supported by a vehicle head rest pole, said totes engaged and suspended from said second loop.

4) A strap device according to claim 1, wherein said first loop is supported by a user's hand or forearm.

5) A strap device according to claim 1, wherein said first loop is supported by a larger structure, wherein said larger structure includes a circumferentially accessible member to engage said first loop therethrough.

6) A strap device according to claim 1, wherein said first and second closure means are snap buttons.

7) A strap device according to claim 1, wherein said first and second closure means are patches of hook and loop fasteners.

8) A strap device according to claim 1, wherein said first and second closure means are button with associated button holes.

9) A method of organizing and supporting load from one or a plurality of totes, comprising the steps of:
folding a first end of said strap on itself to form a first closed loop;
securing said first closed loop with a first snap button;
placing a second end of said strap through one or a plurality of said tote handles and folding said second end on itself to form a second closed loop;
securing said second closed loop with a second snap button.

10) A method as described in claim 9, further comprising the steps of:
supporting said first loop with a grocery cart.

11) A method as described in claim 9, further comprising the steps of:
supporting said first loop with a vehicle seat head rest pole.

12) A method as described in claim 9, further comprising the steps of:
supporting said first loop with a user's hand or forearm.

13) A method as described in claim 9, further comprising the steps of:
supporting said first loop with a circumferentially accessible member of a support structure, said member engaging said first loop therethrough.
